(19) United States
(12) Patent Application Publication
(10) Pub. No.: US 2012/0247083 A1
(43) Pub. Date: Oct. 4, 2012

(54) POROUS CORE COWLING FOR A TURBOJET ENGINE

(75) Inventors: Matthieu LEYKO, Melun (FR); Julien Szydlowski, Paris (FR)

(73) Assignee: SNECMA, Paris (FR)

(21) Appl. No.: 13/434,163

(22) Filed: Mar. 29, 2012

(30) Foreign Application Priority Data
Mar. 30, 2011 (FR) 11 52634

(51) Int. Cl. F02K 3/02

(52) U.S. Cl. 60/226.1

(57) ABSTRACT

A core cowling for a bypass turbojet engine consisting of an internal wall (7) bathed in the main airflow (1) of said turbojet engine and an outer wall (6) bathed in the secondary airflow (2) thereof, the two walls between them forming a cavity (5) which receives the ventilation airflow originating from the hot parts of the turbojet engine to be injected into the secondary airflow through said outer wall, wherein said outer wall is pierced with multiple perforations (8) which are uniformly distributed on the circumference of said barrel and spread longitudinally along said outer wall in the direction of flow of the secondary airflow (2), so as to connect said cavity that receives the ventilation airflow to said secondary flow along at least two parallel circles of perforations.

### BACKGROUND OF THE INVENTION AND DESCRIPTION OF THE PRIOR ART

The field of the present invention is that of aeronautics and, more specifically, that of bypass turbojet engines.

A bypass turbojet engine consists of a gas turbine which drives a ducted fan, generally positioned upstream of the engine. The mass of air drawn in by the engine is split into a main airflow which flows through the gas turbine, and a secondary airflow, which originates from the fan, the two flows being concentric. The main airflow leaves the fan to pass through the primary spool where it is once again compressed, heated in a combustion chamber, guided to successive turbine stages then ejected as a main exhaust flow. The secondary airflow is compressed by the ducted fan stage then ejected directly without having been heated. The two flows may be exhausted separately as two concentric flows or alternatively may be mixed in one and the same pipe before they are exhausted. One or more turbine stages of the main spool are dedicated to driving the fan. The turbojet engine is housed in a nacelle which is shaped to make the aerodynamic drag as low as possible. In the case, to which the invention relates, of a turbojet engine in which the main airflow and the secondary airflow are ejected separately, the nacelle, which comprises a first part enveloping the fan part, ends at the downstream side in a second part that forms the fairing for the primary spool. The shrouds for the two airflows each, at the downstream end, end in a respective tail pipe, one for the main airflow and one for the secondary airflow, these two airflows being separated as far as their point of convergence by a fairing known as the core cowling.

Moreover, the elements that make up the primary spool are cooled by air which is bled off upstream of the engine and conveyed, after this cooling has been performed, toward the rear of the engine where it is expelled to the outside at the tail pipes for the two airflows. This air is generally exhausted into the secondary airflow, at a point where the pressure of the secondary airflow is slightly lower than that of the air being exhausted in order to ensure that it flows in the correct direction. In the versions known from the prior art, this ventilation air flows between the hot parts and then is collected at the core cowling, through which it passes in order to meet up with the secondary airflow. In order to achieve that, the core cowling is made as two parts, a circular slot, known as the core vent, separating these two parts in order to allow the ventilation airflow through. An example of such an embodiment is given in FIG. 1. For aerodynamic reasons connected with the reinjection of the ventilation airflow into the secondary airflow, the two lips of the core vent have different diameters so that the ventilation air can be reinjected in a direction tangential to the direction of flow of the secondary airflow. While this solution has the advantage of ease of manufacture and of reducing friction by creating a film of air between the secondary airflow and the core cowling, it also has the disadvantage of creating a step in the flow of the secondary airflow, and this leads to aerodynamic losses which are detrimental to the propulsion efficiency of the turbojet engine.

### SUMMARY OF THE INVENTION

It is an object of the present invention to address these disadvantages by proposing a device via which the ventilation airflow of the primary spool can pass through the core cowling without having some of the disadvantages of the prior art and, in particular, which reduces the aerodynamic losses that are detrimental to the propulsion efficiency of the turbojet engine.

To this end, a subject of the invention is a core cowling for a bypass turbojet engine consisting of an internal wall bathed in the main airflow of said turbojet engine and an outer wall bathed in the secondary airflow thereof, the two walls between them forming a cavity which receives the ventilation airflow originating from the hot parts of the turbojet engine to be injected into the secondary airflow through said outer wall, wherein said outer wall is pierced with multiple perforations which are uniformly distributed on the circumference of said cowling and spread longitudinally along said outer wall in the direction of flow of the secondary airflow.

The presence of multiple holes, which are small and distributed in a sufficiently dense pattern, means that the air film emerging can be considered to be homogeneous and that friction between the secondary airflow and the core cowling is reduced. The pressure drops in this airflow are therefore likewise reduced.

Advantageously, the repeat pattern for the positioning of the perforations is a square, the perforations situated upstream being aligned, in the direction of flow of the secondary airflow, with the perforations situated further downstream.

Alternatively, the repeat pattern for the positioning of the perforations is a diamond, the major axis of the diamond being aligned with the direction of flow of the secondary airflow.

As a further alternative, the repeat pattern for the positioning of the perforations is a quincunce, the sides of the quincunce being aligned with the direction of flow of the secondary airflow.

In one preferred embodiment, the perforations are cylinders of revolution, their axis of symmetry being inclined by an angle smaller than 30° with respect to the plane tangential to said outer wall at the relevant point.

In a more preferred embodiment, the angle by which the axis of symmetry is inclined is smaller than 20°.

For preference, the longest dimension of at least some of the perforations is shorter than 1 cm.

More preferably still the longest dimension of at least some of the perforations is shorter than 1 mm.

Advantageously, the longest dimension of the perforations is constant from upstream to downstream in the direction of flow of the secondary airflow.

The invention also relates to a bypass turbojet engine comprising a core cowling as described hereinabove.

### BRIEF DESCRIPTION OF THE DRAWINGS

The invention will be better understood, and other objects, details, features and advantages thereof will become more clearly apparent during the course of the detailed explanatory description which follows, of a number of embodiments of the invention which are given purely by way of illustrative and nonlimiting examples with reference to the attached schematic drawings.

In these drawings:

FIG. 1 is a view in cross section of half of a core cowling according to the prior art,

FIG. 2 is an isometric view of a tail pipe comprising a core cowling according to one embodiment of the invention,

FIG. 3 is a view in longitudinal section of the tail pipe of FIG. 2, in the first embodiment,

FIG. 4 is a detail of FIG. 3,

FIGS. 5 and 6 are views of the holes in the core cowling according to the first and second embodiments of the invention, respectively.

Reference is made to FIG. 1 which shows the afterbody of a bypass turbojet engine, which essentially means the part situated downstream of the rotating parts, which ducts both primary air 1 from the hot parts of the engine and secondary air 2 from the fan thereof. These two airflows are separated by a core cowling 10, formed of two sheet metal cone frustums which meet at a bevel at the confluence of the two airflows. Also visible is a ventilation airflow 3 originating from the hot parts of the turbojet engine and which, having cooled these hot parts, is conveyed to the primary and secondary tail pipes in a cavity 5 formed by the two metal sheets of the core cowling 10, and which is injected into the secondary airflow 2 by passing through a slot 4 made in the outer wall 6 of the core cowling 10. The longitudinal position of this slot 4 on the core cowling 10 is chosen according to the pressure of the ventilation airflow 3 and according to the pressure obtained in the secondary airflow at the relevant point, so that this flow is always in the direction of discharging from the cavity 5 toward the secondary airflow 2. The ventilation airflow 3 then creates a film of air which brushes over the core cowling 10 over the entire length thereof which is situated downstream of the slot 4, thus reducing friction between the secondary airflow 2 and the outer wall 6 of the core cowling.

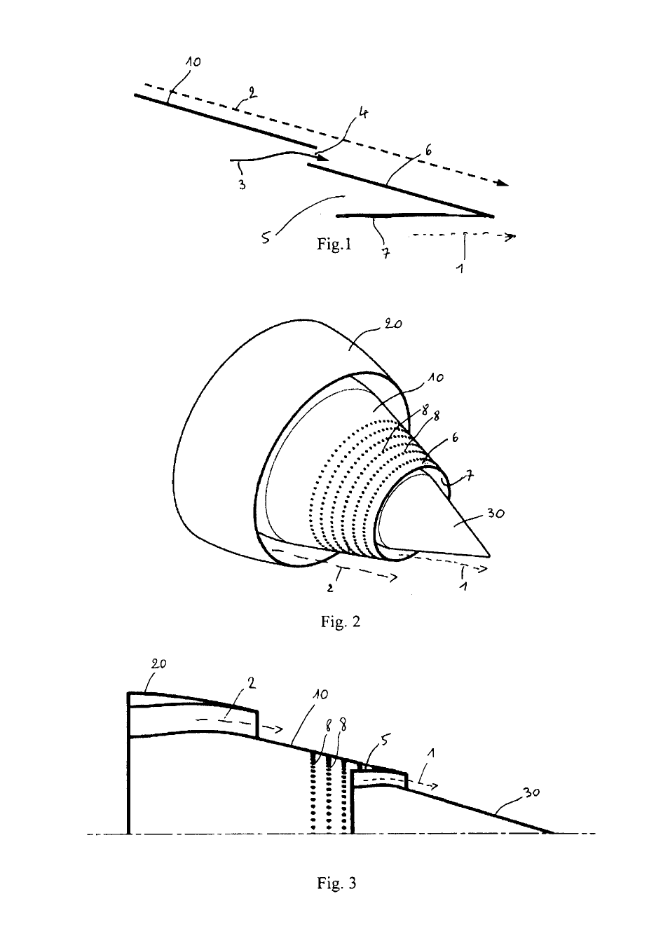

FIG. 2 shows an afterbody of a bypass turbojet engine comprising a core cowling 10 of cylindrical shape consisting, as before, of two metal sheets meeting at a bevel to form the confluence of the two airflows—the main airflow 1 and the secondary airflow 2. The outer face 6 of the core cowling 10, which in this instance is as one piece, guides the secondary airflow 2 whereas its inner face 7 guides the main airflow 1 arriving from the hot parts of the engine. The secondary airflow is routed between, on the one hand, the core cowling 10 and, on the other hand, the downstream part of the nacelle 20, the upstream part of which envelopes the fan of the turbojet engine, this downstream part with the external face of the core cowling, forming the tail pipe for the secondary airflow. The figure also shows the tail cone 30 which guides the main airflow 1 of the turbojet engine after it has passed through the engine and the hot parts thereof. This main airflow thus flows between the cone 30 and the inner face 7 of the core cowling 10.

FIG. 2 shows perforations 8 made in the outer wall 6 of the core cowling 10 and which place the internal cavity 5 of the core cowling in which the ventilation airflow 3 from the hot parts ends up, in communication with the secondary airflow 2. These perforations perform the same function as the slot 4 in FIG. 1, which means that they allow the ventilation airflow 3 to escape from the engine, mixing as it does so with the secondary airflow 2.

FIG. 3 shows the same afterbody, in section on a plane passing through the axis of rotation of the turbojet engine. The cone 30 and the inner face 7 of the core cowling 10 are depicted only in their most downstream part, so as to reveal the device that injects the ventilation airflow 3 into the secondary airflow 2, but quite obviously they extend toward the inside of the engine where they are connected to the elements that guide the main airflow 1 leaving the hot parts of the engine.

The perforations 8 are evenly distributed over the surface of the outer wall 6 of the cavity 5 being arranged, according to a first embodiment of the invention, firstly circumferentially over the entire periphery of this outer wall 6 and secondly longitudinally, along several parallel circles spread out along this outer wall.

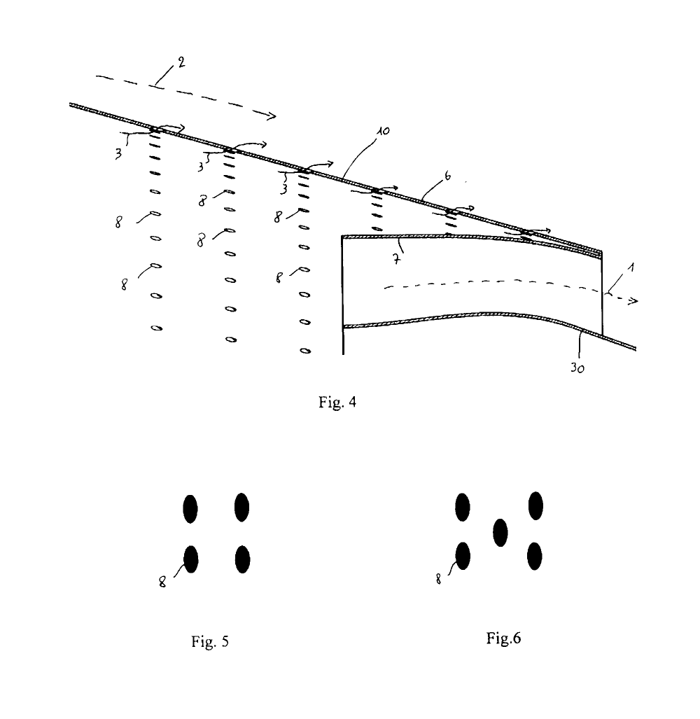

Reference is now made to FIG. 4 which shows in greater detail this same afterbody, indicating the path followed by the ventilation airflow 3 through the orifices 8 in the outer wall of the core cowling 10.

Finally FIGS. 5 and 6 show two embodiments of the invention, consisting of alternative forms of layout of the perforations 8 on the outer wall 6 of the core cowling 10.

In the first embodiment, corresponding to FIG. 5 and visible also in FIGS. 2 to 4, the perforations 8 are arranged circumferentially along parallel circles and are aligned longitudinally along the generatrices of the cone frustum formed by the outer wall 6. In the second embodiment, depicted in FIG. 6, they are positioned in a quincunce configuration, which means that while once again they are arranged circumferentially on parallel circles, they are aligned longitudinally on generatrices of the cone frustum that forms the outer wall 6, two consecutive generatrices being angularly offset by half the circular repeat hitch of the perforations.

It should be noted that both the arrangement and the shape given to the perforations 8 in the two embodiments are merely indicative and that other shapes or other patterns with which they are laid out on the outer wall are possible and fall within the scope of the invention.

In the two embodiments of the invention, the perforations 8 have an oblong elliptical shape, with the major axis directed along the axis of rotation of the engine. This configuration stems from the fact that the axes of these perforations do not run perpendicular to the wall through which they pass, but have been produced at a low pitch angle, which means that their axis makes an angle of a few tens of degrees, typically of between 10 to 30° and preferably of the order of 20° with respect to this wall.

### DESCRIPTION OF THE PREFERRED EMBODIMENTS

The principle of operation of the invention will now be described, taking the first embodiment as an example. Operation in accordance with the second embodiment is exactly the same.

The invention consists in replacing a core cowling that has a step along its outer wall 6, with a porous cowling, thus allowing the ventilation airflow 3 to be exhausted to the outside keeping a one-piece core cowling. This configuration first of all makes the cowling, and the system by which it is attached to the structure of the engine, easier to produce, thus reducing overall manufacturing costs. This solution next has the advantage both of increasing the air film effect, making it possible to reduce the friction of the secondary airflow 2 against the outer wall 6 of the cowling 10 and of getting rid of the downward step that introduced aerodynamic losses in the prior art. In order to make the wall porous and generate an effective air film, cylindrical perforations, the diameter of which varies between a few centimeters and a few tenths of a millimeter, and the axis of symmetry of which, as indicated earlier, is inclined by a few tens of degrees with respect to the wall, are created in the core cowling. These perforations 8 are created in such a number and which such surface areas as to comply with the flowrate required for ventilating the hot parts of the engine. In one preferred embodiment, the longest dimension of the perforations is the same along the entire length of the core cowling.

Whatever the type of perforation adopted (whether these be circular, square or some other shape) and whatever the pattern in which they are arranged (be it rectangular, quincunce or random), the general principle of the invention relies on the fact that the core cowling 10 is porous, which means that it is pierced with a collection of holes that are small enough and distributed densely enough that the film of air emerging therefrom can be considered to be homogeneous. Indeed, increasing the diameter of the holes and reducing the number of them would, admittedly, reduce the associated pressure drops but would also reduce the film effect; the benefit afforded by the invention, namely that of reducing friction between the secondary airflow 2 and the core cowling 10, would then be lost.

Spacing the circles of perforations out over a long length makes it possible through the progressive way in which the film of ventilation air is built up, to obtain a better velocity profile within this film and therefore a greater reduction in the friction between the various layers of which this film is made, and ultimately, a reduction in friction between the secondary airflow and the core cowling.

1. A core cowling for a bypass turbojet engine consisting of an internal wall bathed in the main airflow of said turbojet engine and an outer wall bathed in the secondary airflow thereof, the two walls between them forming a cavity which receives a ventilation airflow originating from the hot parts of the turbojet engine to be injected into the secondary airflow through said outer wall,
wherein said outer wall is pierced with multiple perforations which are uniformly distributed on the circumference of said barrel and spread longitudinally along said outer wall in the direction of flow of the secondary airflow, so as to connect said cavity that receives the ventilation airflow to said secondary flow along at least two parallel circles of perforations.

2. The core cowling as claimed in claim 1, in which the repeat pattern for the positioning of the perforations is a square, the perforations situated upstream being aligned, in the direction of flow of the secondary airflow, with the perforations situated further downstream.

3. The core cowling as claimed in claim 1, in which the repeat pattern for the positioning of the perforations is a diamond, the major axis of the diamond being aligned with the direction of flow of the secondary airflow.

4. The core cowling as claimed in claim 1, in which the repeat pattern for the positioning of the perforations is a quincunce, the sides of the quincunce being aligned with the direction of flow of the secondary airflow.

5. The core cowling as claimed in claim 1, in which the perforations are cylinders of revolution, their axis of symmetry being inclined by an angle smaller than 30° with respect to the plane tangential to said outer wall at the relevant point.

6. The core cowling as claimed in claim 5, in which the angle by which the axis of symmetry is inclined is smaller than 20°.

7. The core cowling as claimed in claim 1, in which the longest dimension of at least some of the perforations is shorter than 1 cm.

8. The core cowling as claimed in claim 1, in which the longest dimension of at least some of the perforations is shorter than 1 mm.

9. The core cowling as claimed in claim 1, in which the longest dimension of the perforations is constant from upstream to downstream in the direction of flow of the secondary airflow.

10. A bypass turbojet engine comprising a core cowling as claimed in claim 1.
